(19) United States
(12) Patent Application Publication
(10) Pub. No.: US 2008/0249642 A1
(43) Pub. Date: Oct. 9, 2008

(54) AUDIO SIGNAL DISTRIBUTION CONTROL SYSTEM

(76) Inventor: Tsai-Yun Chen, Hsin Chu (TW)

Correspondence Address: Dykema Gossett, PLLC, Suite 300 West, 1300 I Street, N.W., Washington, DC, 20005-3306, US

(21) Appl. No.: 11/695,881

(22) Filed: Apr. 3, 2007

(51) Int. Cl. G05B 15/02

(52) U.S. Cl. 700/17

(57) ABSTRACT

An audio signal distribution control system includes a control circuit provided with a device selecting unit, and electrically connected to a plurality of audio signal generating devices; a plurality of control units electrically connected to the control circuit to receive audio signals output thereto by the control circuit and to output control signals to the control circuit; and a plurality of sound producing devices separately connected to the control units. The control units separately select one of the audio signal generating devices via the device selecting unit of the control circuit, and the sound producing devices are adjustable to different sound volumes via the control units.

### FIELD OF THE INVENTION

The present invention relates to an audio signal distribution control system, and more particularly, to an audio signal distribution control system that allows a user to control a plurality of audio signal generating devices from the user end.

### BACKGROUND OF THE INVENTION

In a prior art method of transmitting audio signals, audio signals are transmitted from a central unit to multiple broadcasting units in different locations. The method includes the steps of preparing a plurality of audio programs; selecting a separate audio program for each of the broadcasting units based on particular needs thereof; and transmitting the audio program selected for each broadcasting unit from the central unit to that broadcasting unit. In the above conventional audio signal broadcasting method, the broadcasting of audio programs at multiple broadcasting units is controlled by and at a single central unit.

In another prior art system for distributing audio programs and information over Internet, a plurality of receiving client computers are controlled by the system via an external server to select and receive audio data and related information provided by a plurality of audio content servers. The external server has storage means for storing address information for the plurality of content servers and the receiving client computers, and is able to select audio data and related information provided by a particular content server based on a selection by a receiving client computer and transmits the selected audio data and related information to that receiving client computer for playing thereat.

Generally, a conventional audio signal distribution control system includes a control circuit, and a plurality of audio signal generating devices connected to the control circuit. The control circuit is internally provided with a selecting device for selecting audio signals from one of the plurality of audio signal generating devices. The audio signals selected by the selecting device are transmitted via an audio line to loudspeakers distributed at different locations, so that sound is output at the loudspeakers. The above-described conventional audio signal distribution control system is characterized in that all the audio signal generating devices and the control circuit are arranged in the same one computer room, and a system manager in the computer room may quickly switch between different playing units, such as a DVD (digital versatile disk) player, a CD (compact disk) player, a video recorder, and a computer. And, it is possible to quickly change the sound generating device in each of the playing units. This type of conventional audio signal distribution control system is particularly suitable for a centralized broadcast control system. In this case, a system manager in the control center may quickly and directly change the sound generating device to match requirements at different time points and in different environments or respond to some emergency. For example, the system manager of a music broadcast system in a department store, an intra-building public addressing system, or an intra-company broadcast system between a master control room and different departments may utilize the above-described conventional audio signal distribution control system to send out audio messages, including music, punch-in/punch-out reminding sounds, emergency alarm, etc., to a large number of persons in the store, the building, or the company.

Another prior art invention discloses an audio signal distribution control system that allows a user to select a desired audio data for playing. However, the system is configured over the Internet and must be equipped with additional facilities to provide complete audio data and related information. These additional facilities are highly complicate and would become superfluous if only audio signals are to be transmitted.

While the conventional audio signal distribution control systems have been widely utilized, they only allow unidirectional signal transmission. That is, a system manager selects an audio signal generating device for playing, and audio signals are output to a user end. There is not any mechanism allowing the user to feed back a control signal to the control end in real time. Although it is possible to build a bidirectional control configuration, it involves too many facilities and accordingly, very high cost. Therefore, the conventional audio signal distribution control systems are inflexible and have limited applications because they are restricted to broadcast of audio signals only, and do not allow timely switch among different audio signal generating devices, particularly when the users are located at remote positions from the control center.

It is therefore tried by the inventor to develop an improved audio signal distribution control system that allows a user to control a plurality of audio signal generating devices from the user end.

### SUMMARY OF THE INVENTION

A primary object of the present invention is to provide an audio signal distribution control system, which uses wideband cables to allow transmission of audio signals and control signals over the same one transmission line, so that a user may also control and select directly from the user end a plurality of audio signal generating devices for playing.

To achieve the above and other objects, the audio signal distribution control system according to the present invention includes a control circuit provided with a device selecting unit and connected to a plurality of audio signal generating devices; a plurality of control units being connected to the control circuit to receive audio signals output thereto by the control circuit and to output control signals to the control circuit; and a plurality of sound producing devices separately connected to the control units. Wherein, the control units may select one of the audio signal generating devices via the device selecting unit of the control circuit, and the sound producing devices is adjustable to different sound volumes via the control units. With these arrangements, the audio signal distribution control system of the present invention allows a user to control and select directly from the user end a plurality of audio signal generating devices for playing.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view of an audio signal distribution control system according to a first preferred embodiment of the present invention;

FIG. 2 is a conceptual view of an audio signal distribution control system according to a second preferred embodiment of the present invention; and

FIG. 3 is a conceptual view of an audio signal distribution control system according to a third preferred embodiment of the present invention.

### DETAILED DESCRIPTION OF THE PREFERRED EMBODIMENTS

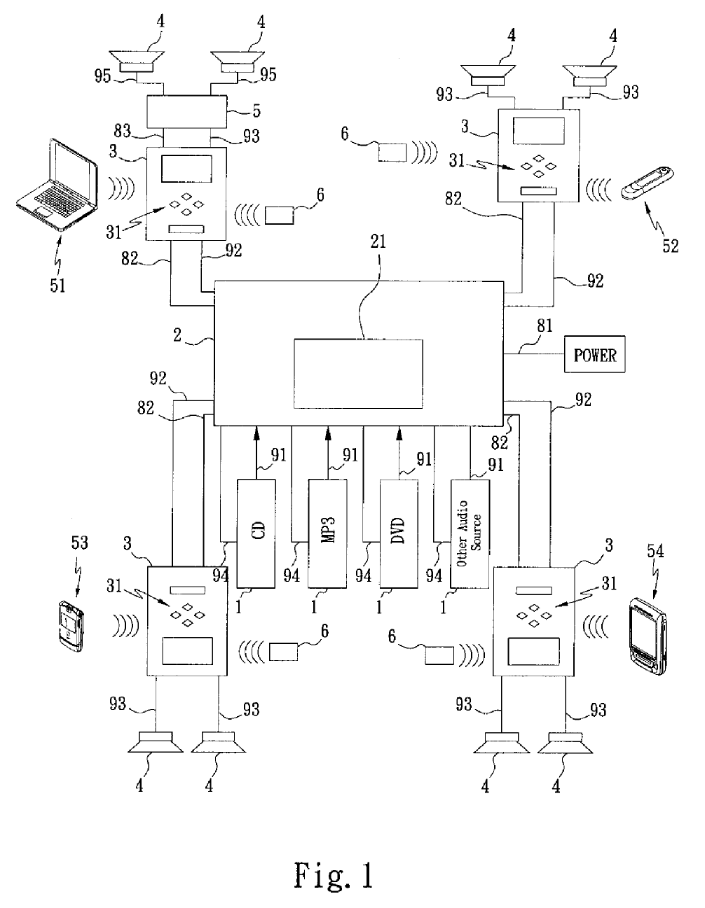

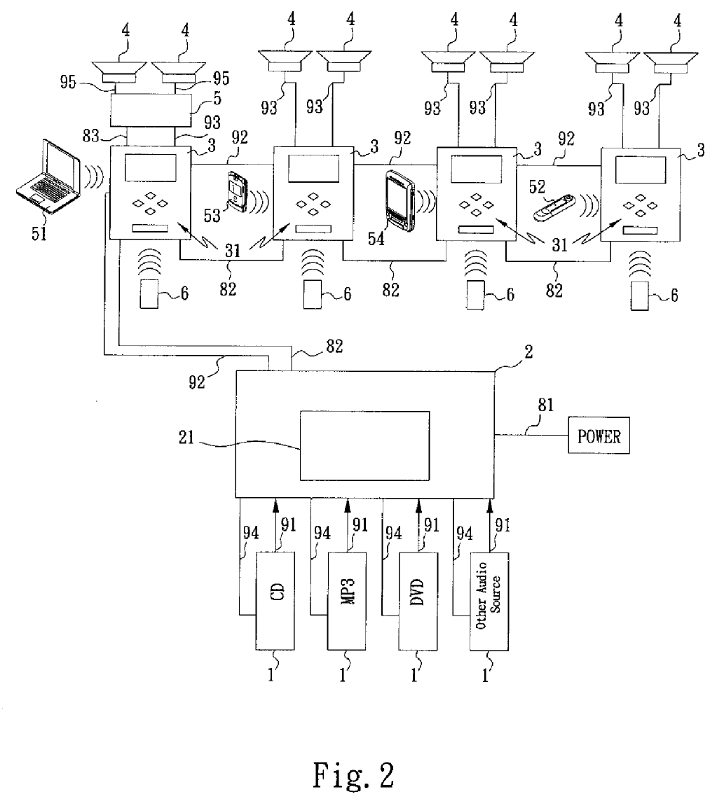

Please refer to FIGS. 1 and 2 that are conceptual views of two audio signal distribution control systems according to a first and a second preferred embodiment of the present invention, respectively. As shown, both the first and the second preferred embodiment of the present invention include a plurality of audio signal generating devices 1, a control circuit 2, a plurality of control units 3, and a plurality of sound producing devices separately connected to the control units 3.

The control circuit 2 is provided with a device selecting unit 21, and electrically connected to the plurality of audio signal generating devices 1, which may include, for example, a compact disk (CD) player, a DVD (digital versatile disk) player, an MP3 player, or other audio sources. The control circuit 2 is also electrically connected to the plurality of control units 3, which are then separately electrically connected to one of the sound producing devices 4 to control the sounding of that sound producing device 4, which may be, for example, at least one loudspeaker.

Audio signals produced by each of the audio signal generating devices 1 are transmitted via an audio line 91 to the control circuit 2. The control circuit 2 may select a particular one of the audio signal generating devices 1 via the device selecting unit 21, and the audio signals generated by that particular audio signal generating device 1 are transmitted to a particular one of the control units 3 via a wideband signal cable 92, which may be, for example, a CAT5E cable. That is, each of the control units 3 independently receives audio signals from a different audio signal generating device 1, and transmit the received audio signals via an audio line 93 to the sound producing device 4 connected thereto. Alternatively, the audio signals received by each control unit 3 may also be transmitted via an audio line 95 to an external amplifier 5 for amplification before being transmitted to the sound producing device 4 via an audio line 95.

Each of the control units 3 is provided with an operation control interface 31, via which a user may adjust the connected sound producing device to a desired sound volume and/or input a control signal. Alternatively, a user may send a control signal from a first remote controller 6 to the control unit 3.

The control signal input by the user at the operation control interface 31 of the control unit 3 is transmitted via the same wideband signal cable 92 to the control circuit 2, at where the control signal is calculated and output via a signal cable 94 to a selected one of the audio signal generating devices 1, so that the user at a remote position may control the control circuit 2 and a particular audio signal generating device 1 via the operation control interface 31 on the control unit 3 or the first remote controller 6. That is, the user may not only select according to personal preference a specific audio signal generating device 1, but also control the content being played by the audio signal generating device 1.

The control circuit 2 is powered via a power cord 81, and supplies power to each control unit 3 via a power cord 82. In the case the control unit 3 is connected to an external amplifier 5, the amplifier 5 may obtain power from the control unit 3 via a power cord 83 or from a separate power cord (not shown).

The control circuit 2 may be connected to each of the control units 3 via a wideband signal cable 92, as shown in FIG. 1. Alternatively, the control circuit 2 may be connected to a first one of the control units 3 via a wideband signal cable 92, and the remaining control units 3 are sequentially connected in series to the first control unit 3 via the wideband signal cable 92, as shown in FIG. 2. In the case as shown in FIG. 2, power is supplied from the control circuit 2 to the control units 3 by connecting the control units 3 to the power cord 82 in series. The audio signal distribution control systems of the present invention adopting the connection manners as shown in FIGS. 1 and 2 achieve the same audio signal distribution control function.

Meanwhile, each of the control units 3 may receive audio signals transmitted from a mobile audio signal generating device, such as, for examples a portable computer 51, a personal digital assistant (PDA) 54, a walkman 52, or a mobile phone 53; and the received audio signals may be played via the connected sound producing device 4. With these arrangements, in an independent room or a conference room, audio signals may be generated from a mobile audio signal generating device, and transmitted to the control unit 3 in that room via Bluetooth, infrared, or microwave communication technique, and then transmitted from the control unit 3 via the audio line 93 to the sound producing device 4 for playing. The sound producing device 4 may therefore create a real-time sound effect or serve as an indoor amplifier. Since such audio signals received from the mobile audio signal generating device are not sent back to the control circuit 2, a small bandwidth is enough for use and the risk of leaking secret information is avoided.

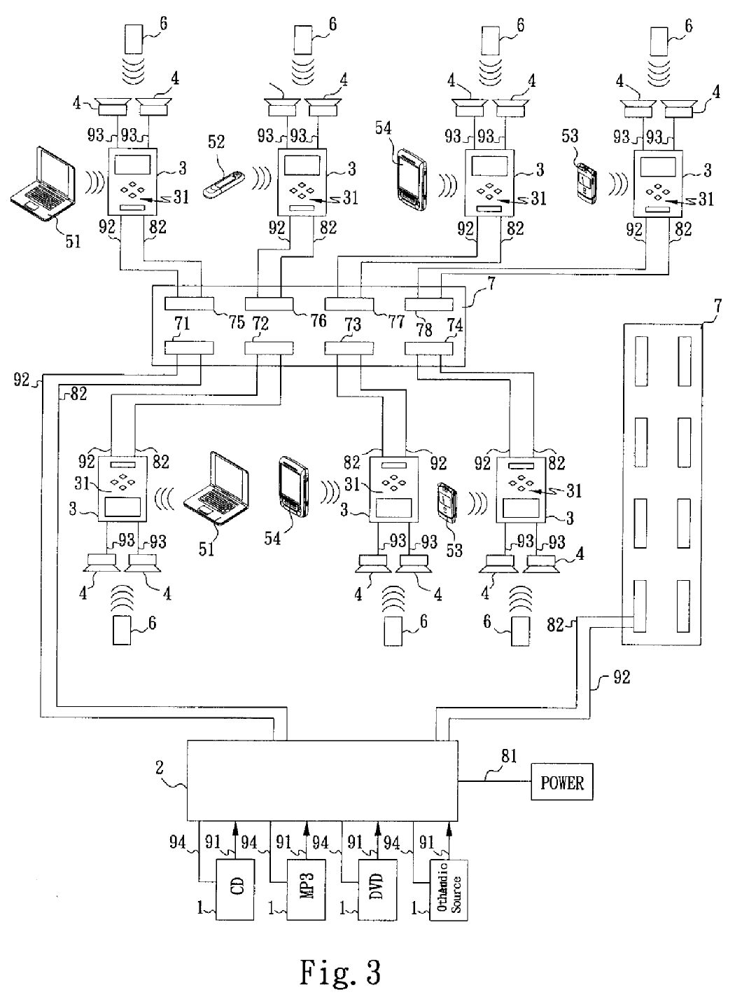

FIG. 3 is a conceptual view of an audio signal distribution control system according to a third preferred embodiment of the present invention. In the third embodiment, a hub 7 is connected between the control units 3 and the control circuit 2, and provided with more than three ports 71 through 78. The control circuit 2 is connected to a first one of the ports 71 through 78 on the hub 7 via a wideband signal cable 92 and a power cord 82. The control units 3 are separately connected to the remaining ports 72 through 78 via a wideband signal cable 92 and a power cord 82 each, so that power may be supplied from the control circuit 2 to the control units 3, and control signals and audio signals may also be transmitted via the wideband signal cables 92 to achieve the same functional effect as in the first and the second embodiment of the present invention. Moreover, the control circuit 2 may also be connected to one or more additional hubs 7 to expand the number of the control units 3. Meanwhile, each of the control units 3 may also receive signals transmitted from a mobile audio signal generating device, and control the connected sound producing device 4 to sound. In the case audio signals are transmitted via a microphone to the individual control units 3, the audio signal distribution control system of the present invention may also serve as an indoor speaker system to provide another economically practical and advanced function.

What is claimed is:

1. An audio signal distribution control system, comprising:
a control circuit provided with a device selecting unit, and electrically connected to a plurality of audio signal generating devices;
a plurality of control units electrically connected to the control circuit to receive audio signals output thereto by the control circuit and to output control signals to the control circuit; and
a plurality of sound producing devices separately connected to the control units; and
wherein the control units separately select one of the audio signal generating devices via the device selecting unit of the control circuit, and the sound producing devices are adjustable to different sound volumes via the control units.

2. The audio signal distribution control system as claimed in claim 1, wherein the control units respectively have an operation control interface, via which a user inputs control signals.

3. The audio signal distribution control system as claimed in claim 1, further comprising a plurality of first remote controllers, with which a user inputs control signals to the control units.

4. The audio signal distribution control system as claimed in claim 1, wherein the control units are separately electrically connected to the control circuit via a wideband signal cable each.

5. The audio signal distribution control system as claimed in claim 1, wherein the control units are separately electrically connected to the sound producing devices via an external amplifier each.

6. The audio signal distribution control system as claimed in claim 1, wherein the control units are connected to one another in series before being electrically connected to the control circuit.

7. The audio signal distribution control system as claimed in claim 1, further comprising at least one hub connected between the control circuit and the control units.

8. The audio signal distribution control system as claimed in claim 1, wherein each of the sound producing devices includes at least one loudspeaker.

9. The audio signal distribution control system as claimed in claim 1, wherein the audio signal generating devices are selected from the group consisting of a CD player, a DVD player, an MP3 player, and other types of audio sources.

10. The audio signal distribution control system as claimed in claim 1, wherein the control units are adapted to receive audio signals transmitted from a mobile audio signal generating device for playing via the sound producing devices.

11. The audio signal distribution control system as claimed in claim 10 wherein the mobile audio signal generating device is a portable computer.

12. The audio signal distribution control system as claimed in claim 10, wherein the mobile audio signal generating device is a PDA.

13. The audio signal distribution control system as claimed in claim 10, wherein the mobile audio signal generating device is a walkman.

14. The audio signal distribution control system as claimed in claim 10, wherein the mobile audio signal generating device is a mobile phone.

15. The audio signal distribution control system as claimed in claim 10, wherein the mobile audio signal generating device transmits audio signals to the control units using infrared communication technique.

16. The audio signal distribution control system as claimed in claim 10, wherein the mobile audio signal generating device transmits audio signals to the control units using Bluetooth communication technique.

17. The audio signal distribution control system as claimed in claim 10, wherein the mobile audio signal generating device transmits audio signals to the control units using microwave communication technique.
